(19) United States
(12) Patent Application Publication
(10) Pub. No.: US 2006/0236246 A1
(43) Pub. Date: Oct. 19, 2006

(54) On-line slide kit creation and collaboration system

(76) Inventors: Charles A. Bono, Gwynedd Valley, PA (US); Ross E. Dworkin, Springfield, PA (US)

Correspondence Address: WILLIAM H. EILBERG, THREE BALA PLAZA, SUITE 501 WEST, BALA CYNWYD, PA, 19004, US

(21) Appl. No.: 11/087,404

(22) Filed: Mar. 23, 2005

(51) Int. Cl. G06F 17/00

(52) U.S. Cl. 715/730

(57) ABSTRACT

A slide kit is assembled with the collaboration of a number of reviewers who may be geographically separated. The slides are posted to a web site which is accessible by the reviewers. The reviewers post comments relating to particular slides. The comments are collated and considered, and a new version of the slide kit is prepared. A disposition diagram is also prepared, either explicitly or internally, to track changes to the slide kit from one version to the next. By keeping track of such changes, the system can associate the various comments with the correct slide, even though the slide numbers may have changed from one version of the slide kit to the next.

### BACKGROUND OF THE INVENTION

This invention relates to the field of information management, and provides a system and method for creation and modification of slide kits for use in educational presentations or other fields.

Slides are frequently used in the delivery of oral presentations, whether in academic environments, in business, or in other fields. The term “slide” originally referred to a translucent photographic film that would move (“slide”) into position in a projector, for viewing on a screen. Modern technology has largely replaced the old photographic slide by a computer-generated image that is projected onto a screen.

Modern “slides” are typically created by known software programs, such as PowerPoint (the term PowerPoint is a trademark of the Microsoft Corporation, of Redmond, Wash.). The images created by these programs are still called “slides”, even though they are not photographic, and do not physically “slide” through anything.

In this specification, the term “slide” is used in its most general meaning, to include both conventional photographic slides, as well as computer-generated images. Indeed, in this specification, the term can refer to any display of information, whether the display is static or moving (such as a video), provided that that display can be handled as a unit, and placed in a series containing other similar or dissimilar units.

In various technical fields, the preparation of a set of slides, for use in an oral presentation, can be a substantial project. The slides will, in general, contain much technical material, which may be the result of considerable research, and which may include many facts, the details of which may be known only to a small number of experts.

For example, if the presentation is in the field of medicine, the set of slides used to illustrate the presentation may include much information that needs to be reviewed by a panel of physicians, scientists, and other experts.

The process of assembling and reviewing a set of slides can be difficult and time-consuming, not only because of the potentially large number of slides needed for a given presentation, but also because of the need to consult various experts, in geographically disparate locations, to insure the correctness and applicability of the slides.

The present invention provides an on-line system and method which greatly facilitates collaboration among a potentially large number of experts, in the assembly and review of slide kits. The invention also provides a system and method for keeping track of changes made to each such slide kit.

### SUMMARY OF THE INVENTION

The present invention comprises a method of creating a slide kit. According to this method, a set of slides is electronically accessed by a group of reviewers, who may be in the same location or in different locations. The reviewers may post comments relating to any or all of the slides, each comment being associated with a particular slide. The slides associated with each comment are collated, so that all comments made with respect to a particular slide can be viewed together. A facilitator, or editor, examines the comments, and assembles a modified set of slides, taking into consideration the comments received from the reviewers. In general, slides may be added, deleted, or modified, to produce the revised slide kit.

In another embodiment of the invention, the facilitator prepares a disposition diagram which illustrates the changes made to the slide kit, between one version and the next. This diagram links various slides in the original set with slides in the modified set. Thus, the facilitator can easily see which slides are common to both sets, and how the slides of the first set may have been renumbered in the modified set. The diagram also indicates which slides have been inserted or deleted when compiling the modified set.

The disposition diagram need not be shown explicitly, but could instead be internally generated, so that the system can automatically associate the various comments with the correct slide numbers in the modified slide kit.

The process of reviewing and modifying slide kits may be repeated one or more times, until the slide kit is in a desired form.

The process may include sending revised slide kits to all of the reviewers, or only to the reviewers who have suggested changes to any of the slides. Alternatively, the process may include sending, to the reviewers, only the slides that have been changed, to solicit further comment. In another alternative, slides may be sent to fewer than all of the reviewers, based on any other selection criterion.

The invention also includes a system for practicing the above-described methods.

The present invention therefore has the primary object of providing a system and method for creating a slide kit for use in educational presentations or in other fields.

The invention has the further object of providing a web-based system and method in which a plurality of reviewers, who may be in geographically disparate locations, collaborate in the creation and modification of a slide kit.

The invention has the further object of providing automated, or semi-automated, graphical means for tracking changes to a slide kit, from one version to the next.

The invention has the further object of providing automated, or semi-automated, means for associating comments, made to a particular slide, with a correct slide number, even when the slide kit has been substantially modified.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a flow chart illustrating the basic steps in the method of the present invention.

FIG. 2 provides a diagram showing a typical screen, used in the present invention, illustrating a hypothetical slide, and showing the relevant comments made by various experts.

FIG. 3 provides a diagram which represents a typical screen, as seen by a facilitator or editor of a slide kit, in the preparation of slide kits according to the present invention.

FIG. 4 provides a diagram representing a screen viewed by the facilitator or editor of a slide kit, according to the present invention, the screen providing means for enabling the editor to document and track the changes made between successive versions of a slide kit.

FIG. 5 provides a diagram representing a display, viewed by the facilitator or editor of a slide kit, according to the present invention, the screen containing a diagram illustrating the changes made in successive versions of a slide kit.

FIG. 6 provides a diagram similar to that of FIG. 5, except that the diagram symbolically represents the slides of three successive versions of the slide kit.

### DETAILED DESCRIPTION OF THE INVENTION

The present invention comprises a system and method for on-line collaboration in the creation of slide kits. The term “creation”, as used herein, refers to the process of selecting slides for inclusion in a slide kit, reviewing such slides, and arranging the slides in an optimum order.

The present specification does not provide details concerning the actual creation of individual slides, as it is assumed that the user of the system has the available software (such as Microsoft PowerPoint or its equivalent) to create the slides.

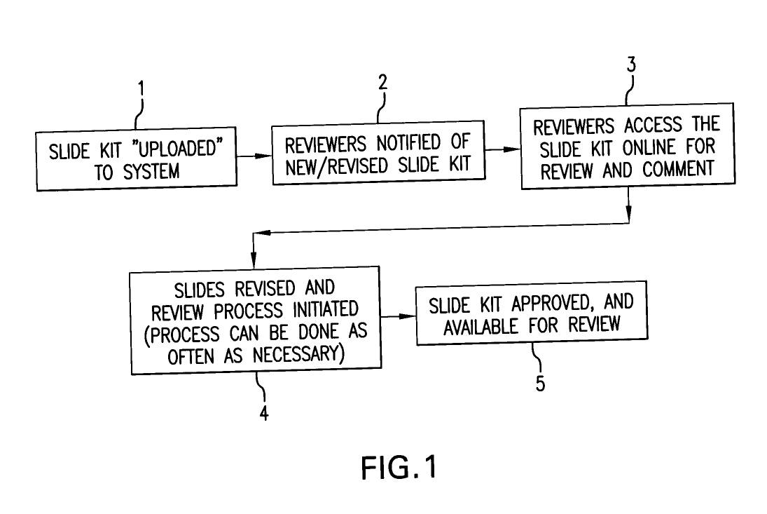

FIG. 1 provides a flow chart that shows the basic steps of the process of the present invention. In block 1, a slide kit is uploaded to a computer memory, such that the kit becomes accessible to a plurality of reviewers. Preferably, the computer memory comprises an Internet web site which can be accessed by the reviewers through an ordinary Internet connection.

In block 2, the reviewers are notified of the availability of the slide kit that has been uploaded to the system. In general, the reviewers may be any set of persons who have been designated to provide feedback on the contents of the slide kit. In practice, the reviewers may be selected experts in the field to which the slide kit pertains. The notification of the reviewers may be by telephone, by fax, by email, or by any other means. In general, the reviewers may be located in geographically disparate places, but some or all of the reviewers could be in the same place.

In block 3, the reviewers access the web site containing the slide kit, and review the slides. The system allows each reviewer to enter comments on each slide. The various reviewers need not review the slides simultaneously. In general, since the reviewers may be located in different places, they will likely access the slide kit at different times. Each reviewer will provide his or her feedback, preferably by typing comments onto a provided field on a screen display of the web site. Such typed comments later become available for review by a facilitator or editor of the slide kit, as well as by other reviewers. The system electronically associates these comments with the slide being viewed by the reviewer. Thus, with every comment, there is associated a number which represents a slide in the slide kit being reviewed.

In block 4, the slide kit is revised by the facilitator or editor, preferably taking into account some or all of the comments made by the reviewers. This revision step could include the creation of entirely new slides, or the creation of new slides which comprise modifications of slides of the previous set, using known software as described above. The revision step could also include altering the order of slides in the kit, and/or eliminating individual slides entirely. When the slide kit has been revised, the editor uploads the new kit onto the web site. In block 5, the slide kit has been approved, and is available for review.

The invention includes several variations in the process of making a revised slide kit available to the reviewers. For example, the system can enable the facilitator to make specific slides accessible by particular reviewers. Thus, the facilitator would be able to direct a modified slide only to the reviewer(s) who need to review that slide.

In another variation, the system can be programmed to make slides selectively available to some or all of the reviewers, by automated means. For example, the system can be set so that only slides that have been commented on are uploaded and available to be seen by the reviewers. Or the system can be set so that only those reviewers who have suggested changes to any of the slides will see some or all of the revised slides. Also, the facilitator could set the system manually, so that the revised slides are made available to individually selected reviewers, the selected reviewers being chosen according to any criterion. In general, the system can be programmed to make slides available to a group of reviewers, wherein such group comprises fewer than all of the available reviewers.

The above-described variations are optional, and if they are desired, they can be used singly or in any combination. Block 4 is therefore intended to include any or all of these variations.

The process represented by the flow chart of FIG. 1 may be repeated one or more times. Thus, in general, the slide kit that is uploaded in block 1 may be an entirely new set of slides, representing the first iteration of the process, or it may be a modified version of a set of slides that has been reviewed previously. The process of review and modification of the slide kits can proceed through as many iterations as desired. Eventually, the process reaches a stage at which the reviewers have no further comments or suggestions.

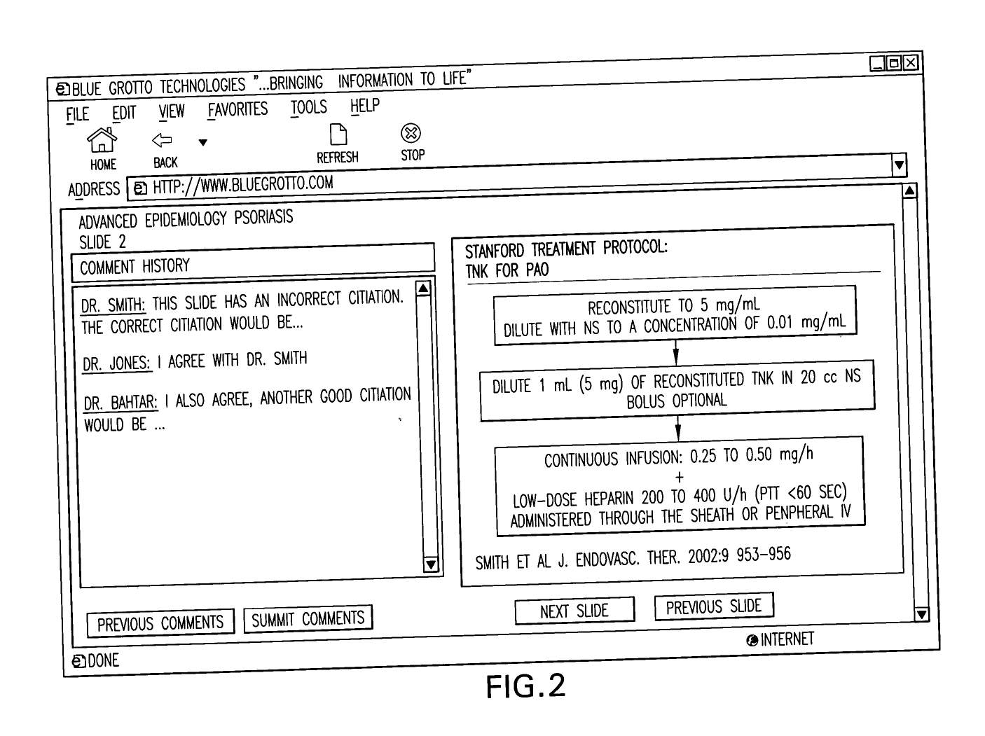

FIG. 2 shows a typical screen display that is accessible by the reviewers participating in the creation of the slide kit. This display embodies the process step described in block 3 of FIG. 1. A hypothetical slide is shown on the right-hand side of the display in FIG. 2. In this hypothetical example, the material shown in the slide is taken from a journal article, the citation of which is shown at the bottom of the slide. The slides may, in general, have any format, and the invention is not limited by the content or format of the slide.

The left-hand side of the display of FIG. 2 contains a set of comments, each comment being associated with the name of the reviewer who submitted it. The comments shown on the display are associated with the slide shown on the right-hand side.

The screen in FIG. 2 provides buttons, at the bottom, to enable the reviewer to control the slides being viewed. In particular, there is a “next slide” button and a “previous slide” button, which enables the reviewer to advance to the next slide in the set, or to return to the previous slide. When the reviewer clicks one of these buttons, the slide displayed on the right-hand side changes accordingly, showing the next slide or the previous slide in the sequence comprising the slide kit.

The reviewer can submit comments on a particular slide by clicking the “submit comments” button. The reviewer would then be presented with an appropriate interface (not shown) for entering a comment. That comment would then be associated with the slide shown on the right-hand side, and would be visible in the comment history, shown on the left-hand side. The reviewer could also see comments pertaining to previous slides by clicking the corresponding button.

The screen shown in FIG. 2 could also include an “approve” button, which could be used, by the reviewer, to signal approval of a particular slide.

In the embodiment represented in FIG. 2, one reviewer is permitted to view all of the comments made by the other reviewers. In an alternative arrangement, the system could be designed such that each reviewer can only view his or her own comments. In the latter case, the facilitator or editor would normally be the only person allowed to view all comments.

The interface represented in FIG. 2 is only one way of implementing the present invention. Other screen displays could be designed, which perform substantially the same function as that of FIG. 2, but which may have different appearances. All such modifications are intended to be encompassed by the present invention.

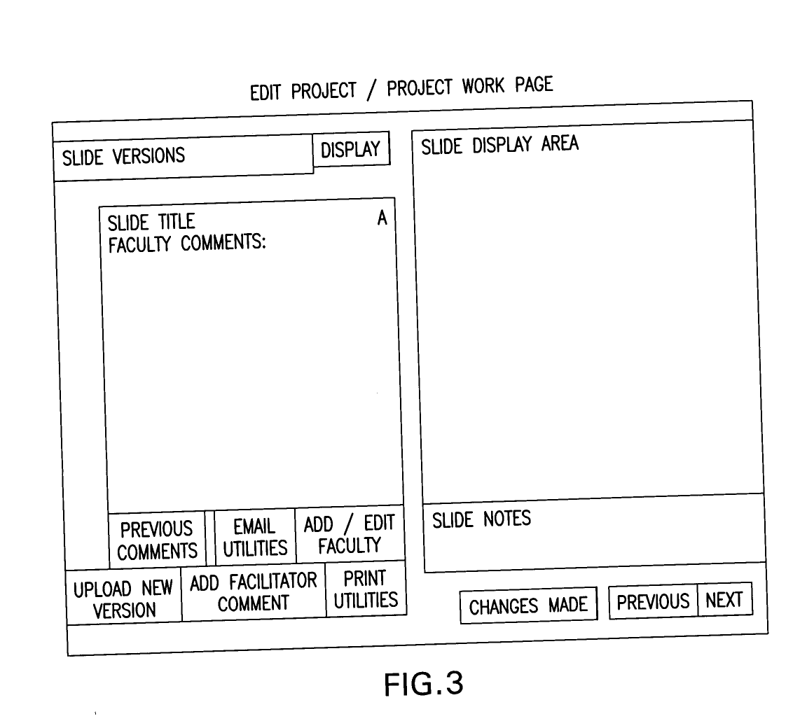

FIG. 3 provides a diagram of a display screen that is used by the facilitator or editor of the slide kit, according to the present invention.

In this specification, the terms “facilitator” and “editor” are used interchangeably. This screen enables the editor to perform the basic tasks associated with the editing of the slide kit.

The box labeled “Slide Versions” indicates the slide kit versions that have been uploaded to the web site. Preferably, each version is identified by a number (not shown). The editor can load a selected version by selecting the version by number. The “Display” button causes the selected version of the slide kit to be loaded into the slide display area. The slide display area preferably shows one slide at a time, from the selected version of the kit. The facilitator uses the “Previous” and “Next” buttons to navigate among the slides in the slide kit. These buttons permit the facilitator to move forward or backward in the set of slides.

Thus, when the facilitator selects a numbered version of the slide kit, the facilitator sees a particular numbered slide on the right-hand side of the display, coupled with the comments made to this slide by the reviewers. The left-hand side of the display indicates the title of the slide, and reproduces all comments that may have been made by any of the reviewers. The system can be programmed to display all previous titles of the same slide, if the title has been modified.

The button labeled “Previous comments” allows the editor to view comments pertaining to this slide, which comments were made relative to a prior version of the slide kit.

The button labeled “Email utilities” allows the editor to email comments to one or more of the group of reviewers.

The button “Add/edit faculty” allows the editor to change information regarding a member of the group of reviewers, or to add or delete reviewers.

The button labeled “Upload New Version” enables the editor to upload a new version of the slide kit, to the web site, for review by the panel of reviewers.

The button labeled “Add facilitator comment” enables the facilitator to add comments to the particular slide shown in the display area.

The button labeled “Print Utilities” provides access, to the editor, to various utilities which allow printing of various reports. For example, the system can be programmed to print a report of every slide in the kit, or of every slide having comments associated therewith, or of other subsets of the slides, based on selected criteria. The printed reports may also include data on system and reviewer usage.

The area labeled “Slide notes” displays the notes associate with the displayed slide. These notes are created by the software (such as PowerPoint) which is used to create the slide, and are not created by the present program or by the editor. Thus, the notes shown in this area can be changed only by making a new slide.

The button labeled “Changes made” enables the editor to provide comments concerning the changes made to a particular slide. These comments can then be read by the reviewers.

The example of FIG. 3 can be modified to accommodate the variations described above with respect to block 4 of FIG. 1. For example, the display may include a button which enables the facilitator to designate a slide as one to be reviewed, thus allowing that slide to be posted again to the web site for further access by the reviewers. The display may include a button and window that allow the facilitator to identify the reviewer(s) who will have access to the indicated slide, and thereby limit the display of the slide to particular reviewers. Also, the display may include buttons that enable the facilitator to select the options of 1) displaying, to reviewers, only slides that have been modified, and/or 2) displaying slides only to reviewers who have suggested changes.

Thus, the present invention should not be considered limited to the specific example represented in FIG. 3. Many alternative ways of displaying the data could be used, and the buttons could be configured differently.

An important aspect of the present invention is the ability to track changes made to the slide kit. During the review process, slides may be added, deleted, and/or moved. A given slide may have a certain number in one version of the slide kit, and another number in a later version. In general, tracking such changes can become overwhelmingly difficult, especially where the number of slides in the kit is moderate or large, and where the kit has been modified many times.

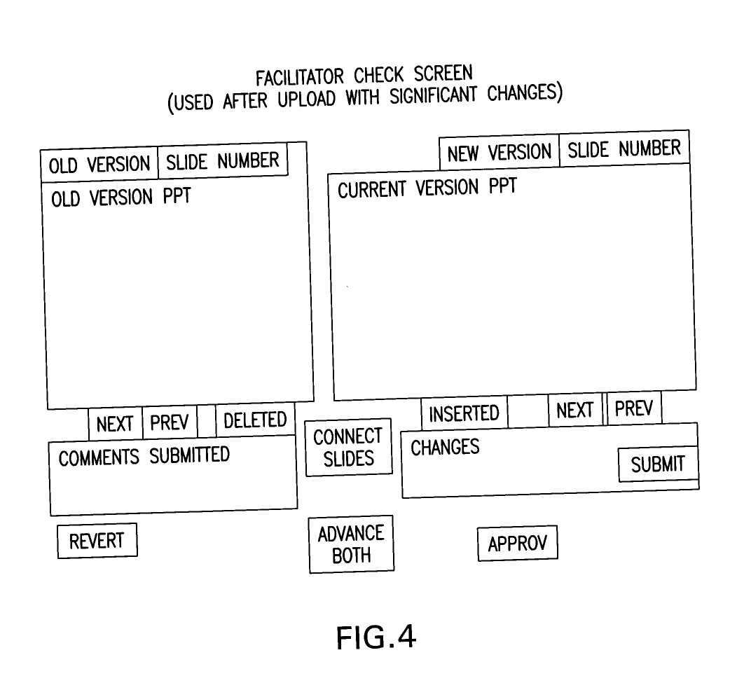

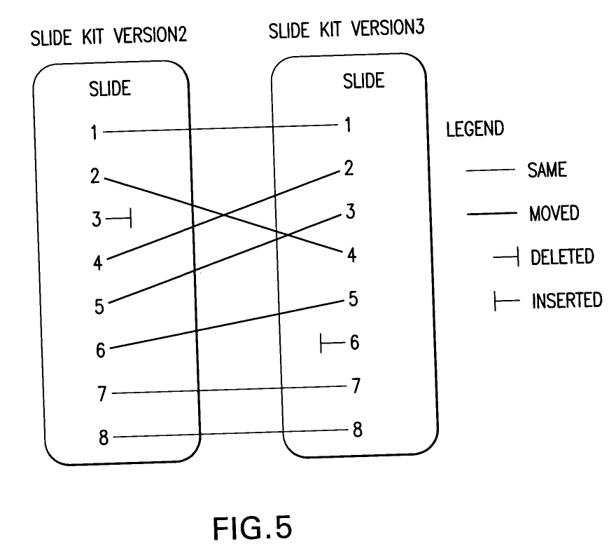

FIG. 5 provides an example of a diagram, for a simplified hypothetical case, generated by the system of the present invention, to show the facilitator or editor the disposition of slides between one version and the next. FIG. 4 provides a sample display screen which the facilitator or editor would use to track the changes, and to generate a diagram of the type shown in FIG. 5.

In the simplified example represented by FIG. 5, Version 2 of a slide kit contains eight slides, and Version 3 of the slide kit contains eight slides. Of these slides, Slide Nos. 1, 7, and 8 are the same in both versions, and occupy the same relative positions in the respective kits. However, Slide 2 of Version 2 has become Slide 4 of Version 3. Slide 3 of Version 2 has been deleted. Slide 4 of Version 2 has become Slide 2 of Version 3, and Slide 5 of Version 2 has become Slide 3 of Version 3. Slide 6 of Version 2 has become Slide 5 of Version 3. Slide 6 of Version 3 is new, and was not included in Version 2. A legend on the right-hand side of FIG. 5 shows the interpretation of the symbols used in the figure, to indicate the disposition of each slide.

FIG. 4 shows the screen used by the facilitator to keep a record of the changes between versions, i.e. to generate the diagram shown in FIG. 5. The space on the left-hand side labeled “Old Version” is used to display slides from the old version, and the space on the right-hand side labeled “Current Version” is used to display slides from the new version.

The slide number of each slide, for the respective versions, are shown in the small blocks above the main displays for both sides. Thus, the large areas on the left and the right are used to display one slide at a time, from the old version (left-hand side) and from the new version (right-hand side).

For example, if the small blocks on the upper left-hand side indicate “Old version, Slide Number 3”, the “Old Version” screen on the left-hand side would show Slide No. 3 of the old version, and so forth. Similar nomenclature is used on the right-hand side, with respect to the slides of the new version.

By clicking the button “Connect Slides”, the facilitator or editor creates a link between the slide on the left-hand side and the slide on the right-hand side. More particularly, the “Connect Slides” function is precisely what creates the lines shown in FIG. 5, which lines indicate which slide from the old version corresponds with which slide from the new version.

The facilitator can scroll through the sequence of slides in the old version and in the new version, by clicking the buttons marked “Next” and “Prev”, for either or both sides of the display. That is, the facilitator navigates through the list of slides, of either or both versions, moving to the next slide, or the previous slide, by clicking on the appropriate buttons. When the slide shown at the left is intended to correspond to the slide shown on the right, the facilitator may click “Connect Slides” to create the solid line that will be shown in the diagram illustrated in FIG. 5.

The button “Deleted”, on the left-hand side, can be used to identify a slide, from the old version, as having been deleted. Activation of this button will cause a “deleted” symbol to appear in the diagram of FIG. 5. In the example given, Slide 3 of the old version has been deleted.

Similarly, the button “Inserted”, on the right-hand side, can be used to identify a slide, from the new version, as having been inserted.

Activation of this button will cause an “inserted” symbol to appear in the diagram of FIG. 5. In the example given, Slide 6 of the new version has been inserted.

By clicking the button labeled “Advance Both”, the displays of both the left-hand side and the right-hand side advance to the next slide in the respective series. This button therefore enables the facilitator to advance the slides in both versions with a single click, avoiding the need to advance the slides separately for the two versions.

The area labeled “Comments submitted” displays the comments made by the reviewers, to the slide shown in the display area of the old version. The area labeled “Changes” is for use by the facilitator, in listing the changes reflected in the new version.

The “Approve” button is used to allow the facilitator to signal approval of a revised version. The “Revert” button is used to eliminate the new version on the web site, and to allow the facilitator to make changes and upload a new version again.

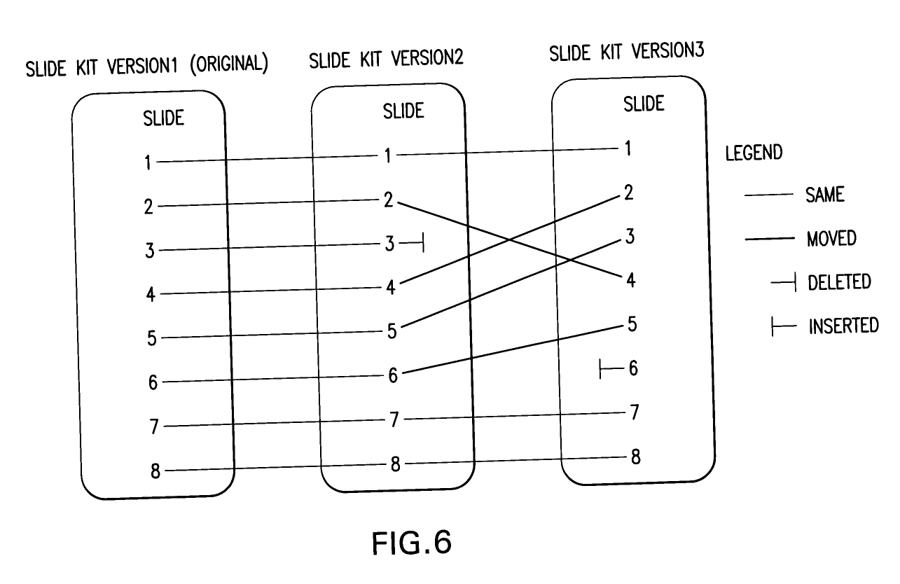

FIG. 6 shows an alternative display constructed according to the present invention. FIG. 6 symbolically represents three successive versions of a slide kit, and shows the disposition of slides from one version to the next. In the example of FIG. 6, the slides of the first version are in one-to-one correspondence with the slides of the second version, but in general, the slides could be inserted, deleted, or moved, just as was done between Versions 2 and 3. The display of FIG. 6 gives the facilitator more complete information about the disposition of slides, by enabling the viewing of three versions at once.

If the embodiment of FIG. 6 is used, it is still preferred that the display of FIG. 4 show only two versions at one time. The reason is that FIG. 4 represents a screen by which the facilitator indicates changes from one version to the next, whereas FIGS. 5 and 6 simply summarize the changes that have already been made. To minimize confusion, and to reduce clutter on the screen, it is desirable that FIG. 4 show only two successive versions at a time.

The method of the present invention is therefore practiced as follows. A group of reviewers, such as a panel of experts in the relevant field, is selected. These reviewers may be located in one place, or in different places. An initial set of slides is selected, and is posted to a web site, or equivalent on-line facility, allowing the reviewers to examine the slides. The reviewers post comments and/or suggestions relating to any or all of the slides, and in one embodiment, all reviewers can see the comments made by the other reviewers, and may post further comments in response, if desired. Each comment is automatically associated with the slide that was being displayed to the reviewer when the reviewer entered the comment. The comments are collated so that each slide, in general, is associated with a plurality of comments. A facilitator or editor reviews all of the comments, and compiles a revised slide kit, taking the comments into consideration. The process is repeated, as the facilitator posts the new version to the website for further review by the panel.

Comments by the reviewers may be made during a specified time interval or “window”. That is, the reviewers may be notified that a slide kit is available for review, and that comments, if made, must be submitted on or before a certain deadline. Thus, the comments can be made by many reviewers, at different times during this time “window”.

When each new version of the slide kit is produced, the facilitator also preferably constructs a diagram showing the disposition of each slide, from one version to the next, and accounting for slides that were deleted and slides that were added. The diagram is constructed with the help of a computer program which facilitates the generation of visual connections between selected slides.

In addition to providing a visual indication of the history of the various slides, the information on disposition of each slide can be used as follows. In general, each comment received from a reviewer is associated with a particular slide number. When the slide kit is modified, many of the slide numbers change. It is therefore necessary, and important, that the comments be keyed to the appropriate slide. A comment to “Slide 4” of a given kit may need to be labeled as a comment to a slide having a different number, in a later version. The disposition diagram of FIG. 5 enables the facilitator to keep track of the changes, and to revise the slide numbers so that each comment is associated with the intended slide.

If the slide kit is large, and/or if the kit undergoes many revisions, the task of keeping track of the disposition of the slides may be very difficult. It is therefore within the scope of the present invention, that the system could be programmed to revise all slide numbers mentioned in a set of comments, in accordance with the disposition information generated.

For example, suppose that FIG. 5 represents the disposition of slides between one version and the next. The system can be programmed to scan each comment. As noted above, each comment is associated with a particular slide number, because the comments are made while the reviewer is viewing a particular slide (as represented in FIG. 2). Thus, the system can be programmed to examine each slide number, from 1 to 8. For comments associated with slide No. 1, no changes are made. For comments associated with slide No. 2, the comments are now associated with slide number “4” in the modified set, because slide No. 2 has been changed to slide No. 4 in the modified set. Comments associated with slide No. 3 are ignored, because that slide is deleted. For comments associated with slide No. 4 in the original set, the comments are now associated with slide No. 2 in the modified set, and so on.

It should be appreciated that the comments themselves need not be changed. What is important is that the comments are associated with the correct slides. When the order of a particular slide is changed, in a modified slide kit, the comments associated with the slide in the original set must be re-associated with the appropriate slide of the modified set. The diagram of FIG. 5 shows how these associations are made.

Thus, FIG. 5 represents not only a graphical representation that can be viewed, and used, by a human facilitator, but it also represents a table that can be internally generated and stored, and used by the system to update the comments by changing the slide numbers associated with some or all of the comments. That is, it is not necessary to display the information represented by FIG. 5, but that information could be used, automatically, to renumber the comments associated with the slides. Thus, the invention can be described as either semi-automated (wherein the human facilitator generates and views the disposition diagram) or automated (wherein the system generates the information and modifies slide numbers accordingly).

Another variation of the invention is the use of codes which are electronically associated with each slide. When a slide kit is created, an electronic code or tag is applied to each slide in the kit, in a manner consistent with the format of the program being used (such as PowerPoint).

For each new revision of the slide kit, the computer program implementing the present invention would track these codes or tags. Each code or tag is unique to a particular slide.

After a new version of the slide kit has been prepared, the program could scan all of the codes of the slides of the new version. Because each code is unique to a particular slide, the program could easily determine which slides have been inserted, which have been deleted, and which have been moved. Thus, by examining all of the codes associated with slides in one version and in the next version, and comparing the codes appearing in both versions, the program could automatically generate diagrams such as those of FIGS. 5 and 6, or could store equivalent information in memory, all without the need for a human facilitator to indicate dispositions. That is, the manual steps represented by FIG. 4 would not be necessary, as the dispositions of slides could be tracked automatically.

The invention includes not only the methods described above, but also the systems necessary to perform the methods. Such systems preferably include one or more programmed computers, including memory, the computers being programmed to display the various slide kits on a web site that can be accessed by the reviewers. The computer is also programmed to accept comments from the reviewers, and to collate such comments so that the comments are correctly associated with the respective slides, and so that the comment can be easily viewed by other reviewers and/or by the facilitator. The computer may be programmed to generate a diagram, such as is shown in FIG. 5 or 6, indicating the origin or disposition of each slide, in comparing a given version of the slide it with the next version.

As noted above, the slides contemplated by the present invention are not necessarily still images. A slide could be a moving picture, i.e. a video, of any length. In its most general form, a slide kit comprises a plurality of units, each unit being either a still or moving image. What is necessary is that the kit comprise a series of discrete units which can be separately labeled and commented upon.

The invention can be modified in many ways, as explained above. The graphical interfaces shown in the drawings represent only one of many possible implementations of the invention. The various modifications, which will be apparent to those skilled in the art, should be considered within the spirit and scope of the following claims.

What is claimed is:

1. A method of creating a slide kit, comprising:
a) providing a plurality of slides, and making said plurality of slides electronically accessible to a plurality of reviewers,
b) accepting comments transmitted electronically by at least some of the reviewers, the comments being associated with particular slides, and
c) assembling a modified plurality of slides in response to comments received from the reviewers.

2. The method of claim 1, wherein step (a) includes posting the slides on an Internet web site.

3. The method of claim 2, wherein step (b) comprises allowing the reviewers to access said Internet web site, and storing information transmitted by said reviewers in response to information displayed on said web site.

4. The method of claim 1, wherein the reviewers are selected to be located in more than one location.

5. The method of claim 4, wherein the reviewers are allowed to make comments within a predetermined interval of time.

6. The method of claim 1, further comprising collating said comments such that all comments received in connection with a particular slide can be displayed in conjunction with said particular slide.

7. The method of claim 1, wherein step (c) includes a step selected from the group consisting of adding, deleting, and modifying individual slides.

8. The method of claim 1, further comprising producing a disposition diagram which illustrates changes made between an original version of the slide kit and a modified version thereof.

9. The method of claim 1, further comprising the step of deriving information about a disposition of slides between an original version of the slide kit and a modified version thereof.

10. The method of claim 9, further comprising the step of using said information about disposition of slides to modify said comments, such that each comment is associated with a correct slide.

11. The method of claim 1, wherein steps (a) through (c) are performed on the modified plurality of slides.

12. The method of claim 1, further comprising repeating step (a) only with respect to slides that have been modified, and then repeating steps (b) and (c).

13. The method of claim 11, wherein the modified plurality of slides is made electronically accessible only to a selected plurality comprising fewer than all of said reviewers.

14. The method of claim 1, further comprising making particular slides again electronically accessible only to reviewers who have previously commented on said particular slides.

15. A method of generating a diagram symbolizing changes made in a slide kit, the method comprising:
a) providing a first plurality of slides, the first plurality of slides belonging to a first version of a slide kit,
b) providing a second plurality of slides, the second plurality of slides belonging to a second version of a slide kit,
c) displaying selected slides from said first and second versions on different portions of a computer screen,
d) establishing connections between at least one slide from said first version and at least one slide from said second version, and
e) graphically representing said connections so as to produce a diagram indicating a disposition of slides between said first and second versions.

16. A method of tracking changes made to a slide kit, comprising:
a) providing an initial plurality of slides, and a plurality of comments associated with at least some of the slides,
b) modifying said initial plurality of slides to produce a modified plurality of slides,
c) tracking correspondences between slides in said initial plurality and slides in said modified plurality, and
d) re-associating comments associated with slides of said initial plurality of slides according to said correspondences tracked in step (c), wherein comments associated with slides of said initial plurality are correctly associated with slides of said modified plurality.

17. The method of claim 16, wherein step (c) is performed by associating a unique code with each slide, and by comparing codes of said initial plurality of slides with codes of said modified plurality of slides.

18. A system for creating a slide kit, comprising:
a) means for providing a plurality of slides, and for making said plurality of slides electronically accessible to a plurality of reviewers,
b) means for accepting comments from at least some of the reviewers, the comments being associated with particular slides, and
c) means for assembling a modified plurality of slides in response to comments received from the reviewers.

19. The system of claim 18, further comprising means for collating said comments such that comments received in connection with a particular slide are displayed in conjunction with said particular slide.

20. The system of claim 18, further comprising means for producing a disposition diagram which illustrates changes made between an original version of the slide kit and a modified version thereof.

21. The system of claim 18, further comprising means for deriving information about a disposition of slides between an original version of the slide kit and a modified version thereof.

22. The system of claim 21, further comprising means for using said information about disposition of slides to modify said comments, such that each comment is associated with a correct slide.
